(19) United States
(12) Patent Application Publication
(10) Pub. No.: US 2025/0005371 A1
(43) Pub. Date: Jan. 2, 2025

(54) CHIPLET ARCHITECTURE FOR INFERENCE, FINE-TUNING TRAINING, AND TRANSFER LEARNING

(71) Applicant: International Business Machines Corporation, Armonk, NY (US)

(72) Inventors: Arvind Kumar, Stamford, CT (US); Mudhakar Srivatsa, White Plains, NY (US); Raghu Kiran Ganti, White Plains, NY (US); Joshua M. Rubin, Albany, NY (US)

(73) Assignee: International Business Machines Corporation, Armonk, NY (US)

(21) Appl. No.: 18/217,522

(22) Filed: Jun. 30, 2023

(51) Int. Cl. G06N 3/096; G06N 3/04

(52) U.S. Cl. CPC G06N 3/096; G06N 3/04

(57) ABSTRACT

A method for training and fine-tuning an artificial intelligence model is disclosed. In one embodiment, such a method distributes, across multiple chiplets of a package, functionality associated with a deep neural network. The method implements, within a first set of chiplets, frozen layers of the deep neural network. By contrast, the method implements, within a second set of chiplets, trainable layers of the deep neural network. The number of chiplets in the second set may be smaller than the number of chiplets in the first set and may consist of a single chiplet in some embodiments. In certain embodiments, the second set of chiplets has one or more of additional memory capacity and additional processing capacity compared to the first set of chiplets in order to train and fine tune the trainable layers. A corresponding apparatus is also disclosed.

### BACKGROUND

### Field of the Invention

This invention relates generally to artificial intelligence, and more particularly to systems and methods for more efficiently training and fine-tuning artificial intelligence models.

### Background of the Invention

Training artificial intelligence models and deploying them for inference typically have different requirements in terms of computing power and memory. For example, training an artificial intelligence model typically involves feeding large amounts of labeled data into the model and adjusting the model's parameters iteratively to optimize its performance. This training is computationally intensive and requires significant computing and memory resources especially for complex models and large datasets. Training typically occurs offline, with the goal being to create an optimized model that captures patterns and relationships in the training data.

On the other hand, inference deployment involves using the trained model to make predictions or decisions on new, unseen data. The computing power required for inference is generally lower than that needed for training. This is due to the reduced complexity of performing inference, where there is no need for gradient computations, backpropagation, or parameter updates required for training. This may also be due to the fact that inference is often implemented on dedicated hardware accelerators, such as GPUs or specialized chips like TPUs (Tensor Processing Units) which can enhance computational efficiency. Inference is often performed on edge devices or in cloud environments, with the goal being to achieve real-time or near-real-time predictions based on the trained model.

### SUMMARY

The invention has been developed in response to the present state of the art and, in particular, in response to the problems and needs in the art that have not yet been fully solved by currently available systems and methods. Accordingly, systems and methods have been developed for training and fine-tuning artificial intelligence models. The features and advantages of the invention will become more fully apparent from the following description and appended claims, or may be learned by practice of the invention as set forth hereinafter.

Consistent with the foregoing, a method for training and fine-tuning an artificial intelligence model is disclosed. In one embodiment, such a method distributes, across multiple chiplets of a package, functionality associated with a deep neural network. The method implements, within a first set of chiplets, frozen layers of the deep neural network. By contrast, the method implements, within a second set of chiplets, trainable layers of the deep neural network. The number of chiplets in the second set may be smaller than the number of chiplets in the first set and may consist of a single chiplet in some embodiments. In certain embodiments, the second set of chiplets has one or more of additional memory capacity and additional processing capacity compared to the first set of chiplets in order to train and fine tune the trainable layers.

A corresponding apparatus is also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2 is a high-level block diagram showing an example of a deep neural network;

FIG. 3 is a high-level block diagram showing a package comprising multiple chiplets;

FIG. 4 is a high-level block diagram showing a chiplet with additional memory capacity;

FIG. 5 is a high-level block diagram showing how the chiplets on the package may perform an inference operation;

FIG. 6 is a high-level block diagram showing a pipeline diagram for fine-tuning the deep neural network implemented in the package disclosed herein;

FIG. 7 is a high-level block diagram showing a pipeline diagram for conventional training of a deep neural network model using forward and backward propagation;

FIG. 8 is a high-level block diagram showing a technique, along with a pipeline diagram, for performing more rapid fine tuning and training adjustments on the package;

FIG. 9 is a high-level block diagram showing exemplary placement of higher and lower speed interfaces within the package; and

FIGS. 10A-E are high-level block diagrams showing another technique for performing more rapid fine tuning and training adjustments on the package.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 (i.e., a “fine tuning module 150”) for more efficiently training and fine-tuning artificial intelligence models. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

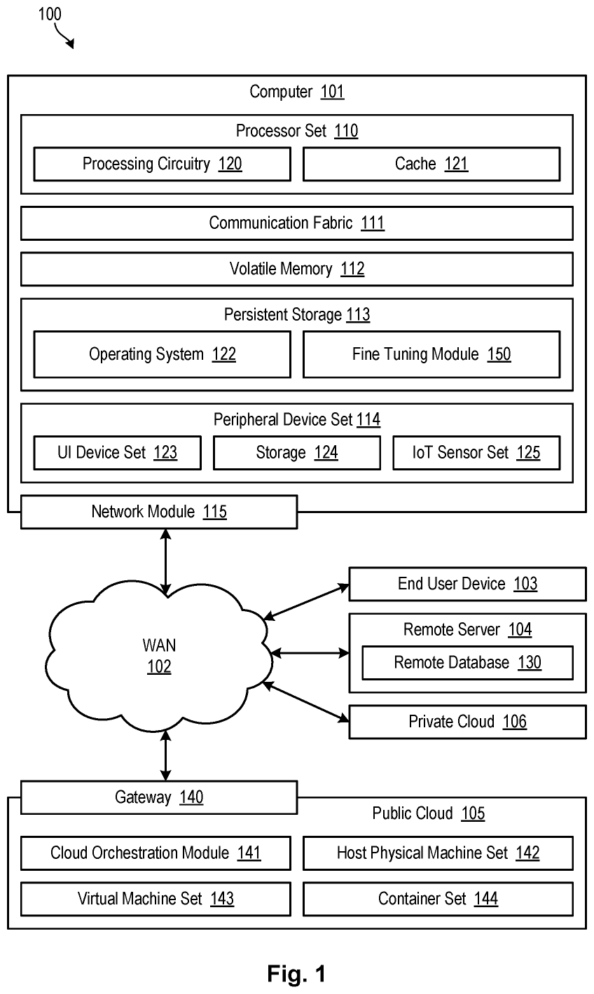

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

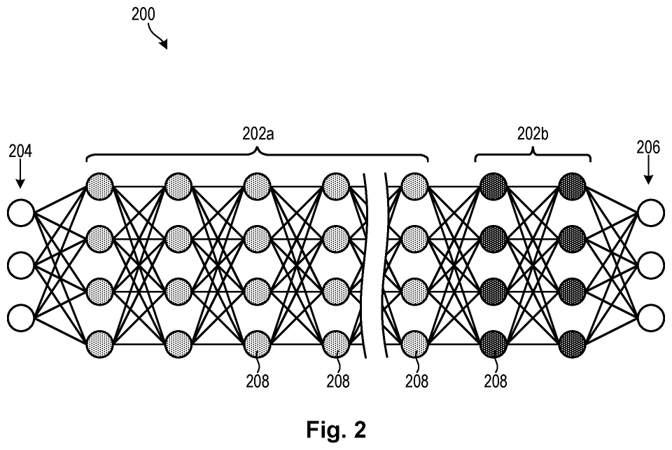

Referring to FIG. 2, as previously mentioned, training artificial intelligence models and deploying them for inference typically have different requirements in terms of computing power and memory. For example, training an artificial intelligence model typically involves feeding large amounts of labeled data into the model and adjusting the model's parameters iteratively to optimize its performance. This training is computationally intensive and requires significant computing and memory resources especially for complex models and large datasets. Training typically occurs offline, with the goal being to create an optimized model that captures patterns and relationships in the training data.

On the other hand, inference deployment involves using the trained model to make predictions or decisions on new, unseen data. The computing power required for inference is generally lower than that needed for training. This is due to the reduced complexity of performing inference, where there is no need for gradient computations, backpropagation, or parameter updates required for training. This may also be due to the fact that inference is often implemented on dedicated hardware accelerators, such as GPUs or specialized chips like TPUs (Tensor Processing Units), which can enhance computational efficiency. Inference is often performed on edge devices or in cloud environments, with the goal being to achieve real-time or near-real-time predictions based on the trained model.

Nevertheless, even after a deployment, a trained artificial intelligence model may require further fine tuning and/or adjustments. This fine-tuning may need to be performed on a system with substantial computing and memory requirements, similar to the initial training, as opposed to on edge devices or cloud environments with lower computing resources. The fine-tuned model may then be re-deployed on an edge device or cloud environment to perform inference operations. This process may need to be repeated each time the artificial intelligence model requires further tuning and/or adjustments. This recurring exchange between training and deployment systems can be both cumbersome and time-consuming. In some cases, the training and deployment systems may not even be owned or operated by the same entities, further increasing the difficulty in transitioning between the two.

To address the issues described above, in certain embodiments, instead of repeatedly transitioning between a higher performance training system and a lower performance deployment system, a deployment system may be provided that enables some fine-tuning and/or adjustments to an artificial intelligence model. In general, as shown in FIG. 2, for a pre-trained base deep neural network 200 that includes multiple hidden layers 202 between an input layer 204 and output layer 206, fine-tuning and transfer learning (i.e., training or fine tuning the base deep neural network 200 to perform a new task) are generally performed on a relatively small number of layers 202b near the output layer 206. That is, only the weights of a last number of layers 202b typically need to be modified to fine tune or optimize a deep neural network 200. By contrast, the weights of the remaining layers 202a generally remain frozen. For the purposes of this disclosure, the layers 202b may be referred to as “trainable layers 202b” and the layers 202a may be referred to as “frozen layers 202a.” The deep neural network 200 shown in FIG. 2 is shown in very simplified form for explanation purposes and may include more or fewer layers 202 and/or neurons 208 within the layers 202 than those that are illustrated.

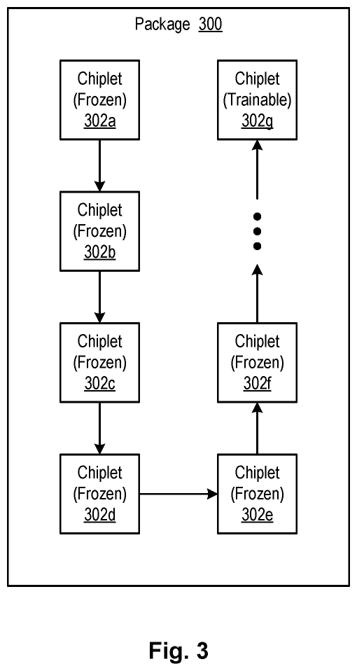

Referring to FIG. 3, as previously mentioned, inference operations associated with an artificial intelligence model may be implemented on dedicated hardware such as GPUs or specialized chips like TPUs to enhance computational efficiency. However, conventional hardware devices are typically not designed to efficiently train or fine tune the artificial intelligence model. FIG. 3 shows one embodiment of a hardware component (i.e., a package 300 comprising multiple chiplets 302) in accordance with the invention that may be designed to perform inference operations associated with an artificial intelligence model. Beneficially, unlike conventional hardware, the package 300 may also be configured to efficiently perform some fine-tuning and training of the artificial intelligence model deployed thereon.

As shown in FIG. 3, in certain embodiments, a package 300 in accordance with the invention may include multiple chiplets 302 in communication with one another. The illustrated chiplets 302 are arranged in series although in other embodiments the chiplets 302 may be arranged in parallel or even a configuration comprising both series and parallel connections. An artificial intelligence model comprising a deep neural network 200 is distributed across the chiplets 302. The package 300 implements, within a first set of chiplets 302a-f, frozen layers 202a of the deep neural network 200. Similarly, the package 300 implements, within a second set chiplets 302g, trainable layers 202b of the deep neural network 200. In certain embodiments, the second set of chiplets 302g is a single chiplet 302g although in other embodiments the second set of chiplets 302g may include multiple chiplets 302g. It should also be recognized that although the chiplets 302 are shown in a single package 300 the chiplets 302 may also be distributed across several packages 300. For example, chiplets 302 with frozen layers 202a could be on a separate package 300 from chiplets 302 with trainable layers 202b.

As shown in FIG. 3, each chiplet 302 in the chain may implement some number of layers 202 (or portions of layers 202) of the deep neural network 200. The output of the layers 202 implemented by a chiplet 302 may be passed to a next chiplet 302 in the chain, where it will be input to the layers 202 implemented by that chiplet 302. The full set of chiplets 302 may, in certain embodiments, implement all layers 202 of the deep neural network 200. As was previously mentioned, for a pre-trained base deep neural network 200 that includes multiple hidden layers 202 between an input layer 204 and output layer 206, fine-tuning and transfer learning are generally performed on a relatively small number of layers 202b near the output layer 206. Thus, in certain embodiments, only a single or smaller number of chiplets 302g in the chain, namely those at the end of the chain, may host layers 202 that are used for fine-tuning and/or transfer learning. The weights or other parameters for the layers 202b implemented by these chiplet(s) 302g may be adjustable. By contrast, weights or other parameters for the layers 202a implemented by remaining chiplets 302a-f may be frozen. Thus, only chiplet(s) 302g may be associated with fine-tuning and/or training the deep neural network 200.

Furthermore, although the illustrated trainable chiplets 302g are located at or near an end of the chain of chiplets 302, in other embodiments trainable chiplets 302g may be placed at other locations within the deep neural network 200 to perform other types of fine-tuning. This is because different methods of fine tuning may modify different portions of the deep neural network 200. Within fine tuning, some current techniques include prompt tuning, head tuning, and LORA (Low-Rank Adaptation of Large Language Models). Prompt tuning modifies a first layer 202 of the deep neural network 200. Head tuning, by contrast, modifies the last layer 202. LORA may add trainable parameters at every layer 202 or transformer block. Thus, in certain embodiments trainable chiplets 302g may be provided at various and even several locations within the deep neural network 200, anywhere between the input layer 204 and the output layer 206.

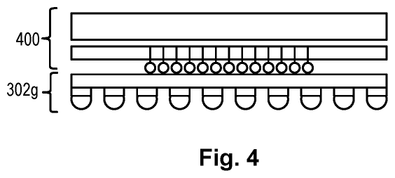

Referring to FIG. 4, because fine-tuning and/or training requires more computing resources (e.g., processing power, memory, etc.) than simply performing inference operations, it follows that the chiplet(s) 302g involved in fine-tuning and/or training the deep neural network 200 may require more computing resources than other chiplets 302a-f of the package 300. Thus, in certain embodiments, the chiplet(s) 302g may be designed to include sufficient on-chip memory (or high bandwidth and/or high capacity memory in close proximity to the chiplet(s) 302g) to accommodate training of the changeable layers 202b, including optimizer states and activations needed for backpropagation. For a set of changeable weights requiring memory capacity w_{c}, the memory must be designed to accommodate αw_{c}, where α is a factor accounting for the training and is typically on the order of three to eight depending on the optimizer. The chiplet(s) 302g may also be designed with sufficient computing performance such that forward/backward propagation of the changeable layers 202b can be performed in a time similar to the forward propagation time of the fixed layers 202a in the other chiplets 302a-f. This may be done to avoid a bottleneck when employing pipeline parallelism. Because changeable weights may be implemented on a single chiplet 302g, demanding bandwidth requirements for training may be accommodated by high on-chip bandwidth.

FIG. 4 shows a conceptual design wherein 3D stacked memory 400 of capacity c is coupled to a chiplet 302g (e.g., an artificial intelligence accelerator) to provide sufficient on-chip memory to accommodate fine-tuning and training of the changeable layers 202b. Storing weight parameters on chip reduces or eliminates off-chip memory accesses, which may be costly in energy and latency. The chiplets 302a-f hosting the frozen layers 202a may, in certain embodiments, not include this additional memory 400 since no fine-tuning or training is performed on these devices, but may otherwise have an architecture that is the same as or similar to the chiplet 302g. These chiplets 302a-f may also, in certain embodiments, store weight parameters on chip to reduce or eliminate off-chip memory accesses.

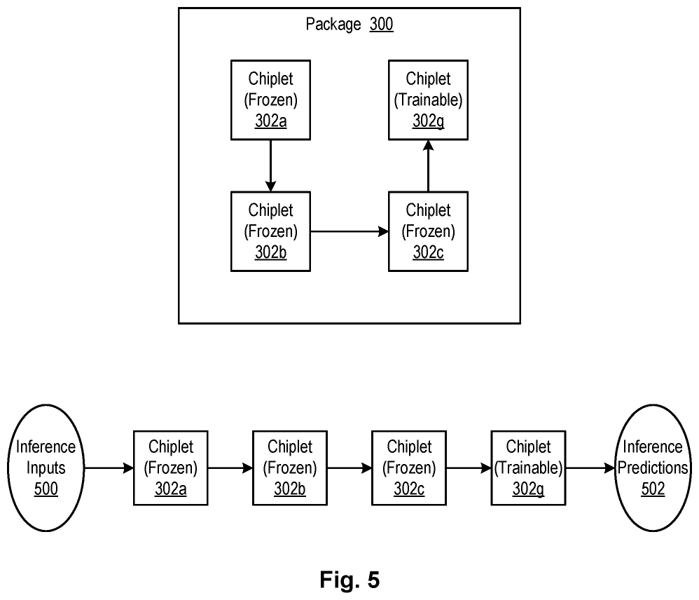

FIG. 5 is a high-level block diagram showing how the chiplets 302 on a package 300 perform inference operations. When in inference mode, a first chiplet 302a in the chain may receive inference inputs 500 and propagate these inference inputs 500 through the fixed layers 202a implemented by the chiplet 302a. The output of the first chiplet 302a may then be propagated in a forward direction through the layers 202 of the other chiplets 302 in the chain to produce inference predictions 502 at an output thereof. Each chiplet 302 in the chain may have enough scratchpad memory to store the activations that are generated within the chiplet 302. The link bandwidth between the chiplets 302 may be designed so that communication latency is small compared to the compute time within the chiplets 302.

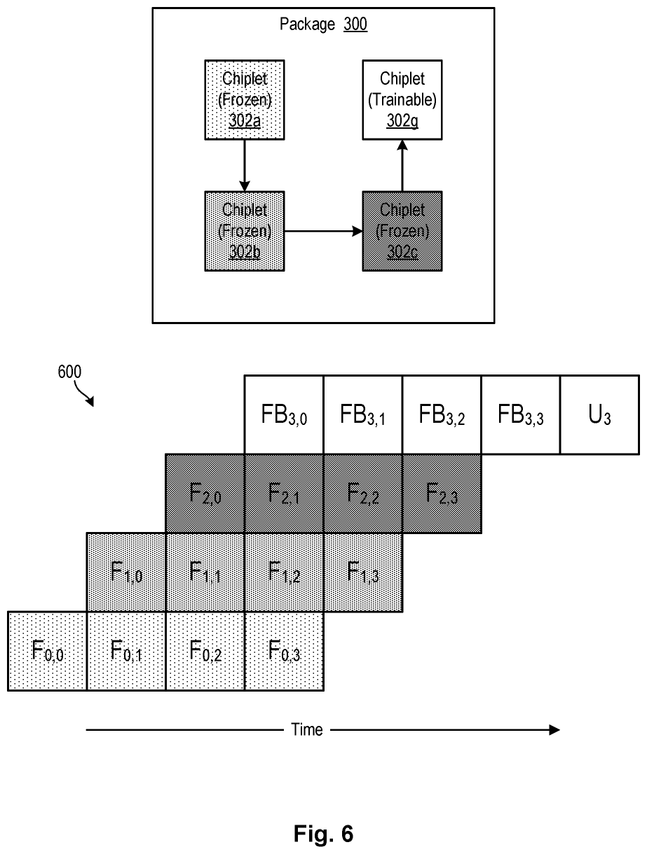

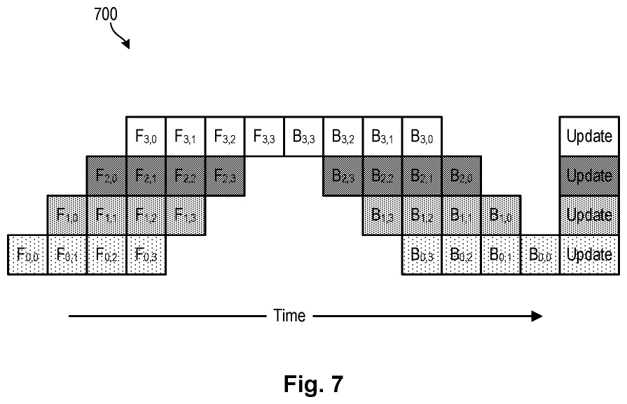

FIG. 6 is a high-level block diagram showing a pipeline diagram 600 for fine-tuning the deep neural network 200. Each box of the pipeline diagram 600 represents a microbatch of data processed by one of the chiplets 302 (four chiplets 302 in this example) of the package 300 when performing fine-tune training on the deep neural network 200. The bottom row of boxes represents the microbatches processed by chiplet 302a, the second to the bottom row of boxes represents the microbatches processed by chiplet 302b, the third from the bottom row of boxes represents the microbatches processed by chiplet 302c, and the top row of boxes represents the microbatches processed by chiplet 302g (i.e., the trainable chiplet 302g). The pipeline diagram 600 (as well as the pipeline diagram 700 shown in FIG. 7) use the following notation: F_{model,μbatch}=Forward Propagation; B_{model,μbatch}=Backward Propagation; FB_{model,μbatch}=Forward+Backward Propagation; and U_{model}=Update. The microbatch size may be selected to be compatible with the batch size when performing inference processing so that training the deep neural network 200 does not impose additional capacity requirements.

As shown in FIG. 6, because weights are only modified in the trainable chiplet 302g, data only needs to propagate in the forward direction starting with chiplet 302a and ending with chiplet 302g. Forward and backward propagation would only occur in the trainable chiplet 302g in order to update the weights in the trainable chiplet 302g. By contrast if all the chiplets 302 were trainable, both forward and backward propagation would be needed through all the chiplets 302, as show in FIG. 7 in order to update the weights in all of the chiplets 302. Thus, using only a single trainable chiplet 302g with the other chiplets 302 having fixed weights significantly reduces processing requirements needed to train the deep neural network 200 compared to having changeable weights in all the chiplets 302.

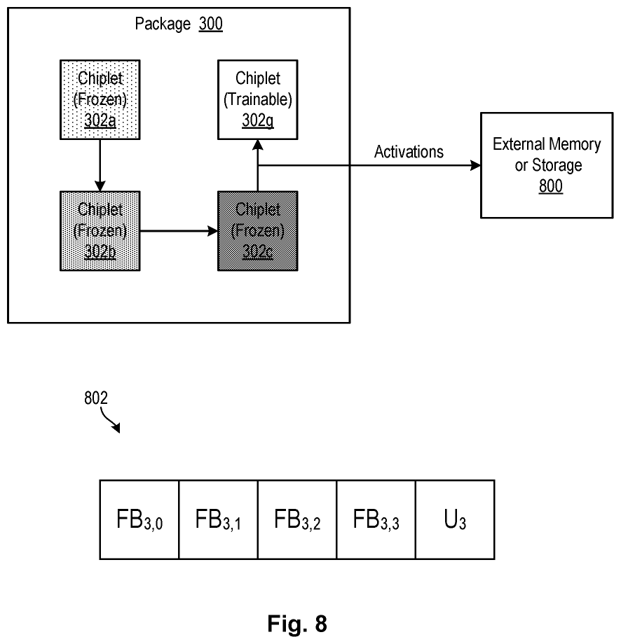

Referring to FIG. 8, an alternative embodiment of a technique for fine-tuning or training the trainable chiplet 302g is illustrated. In this embodiment, during inference operations, activations from the frozen chiplets 302a-c (i.e., frozen layers 202a) are stored in an external memory 800 or storage device 800 either on or off chip. This may be performed for a significant period of time. In order to fine-tune the deep neural network 200 and/or facilitate transfer learning, these activations may be read from the external memory 800 and processed on the trainable chiplet 302g, thereby eliminating the need to regenerate the activations on the chiplets 302a-c during the training process. Only forward and backward propagation is needed on the trainable chiplet 302g in order to train or fine tune the deep neural network 200 as indicated by the pipeline diagram 802 of FIG. 8.

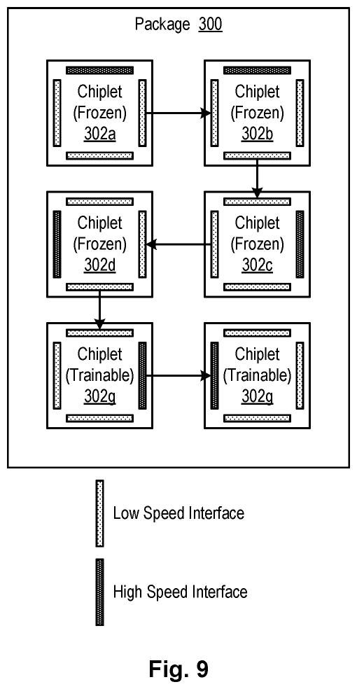

Referring to FIG. 9, as previously mentioned, in certain embodiments a package 300 may include more than one trainable chiplet 302g, such as to accommodate a greater memory requirement. In certain cases, chiplets 302g containing trainable layers 202b may have higher bandwidth requirements in order to satisfy training requirements. This can be accomplished by way of greater serialization and/or advanced packaging (e.g., a bridge between the trainable chiplets 302g). FIG. 9 shows a plurality of chiplets 302 with the same architecture that are arranged in a way to satisfy high speed communication requirements between trainable chiplets 302g, while allowing lower speed communication between frozen chiplets 302, which may be advantageous to reduce power consumption or provide other benefits. More specifically, FIG. 9 shows a plurality of chiplets 302 with a combination of higher and lower speed interfaces, where the higher speed interfaces of the trainable chiplets 302g are aligned and connected to enable higher speed communication therebetween.

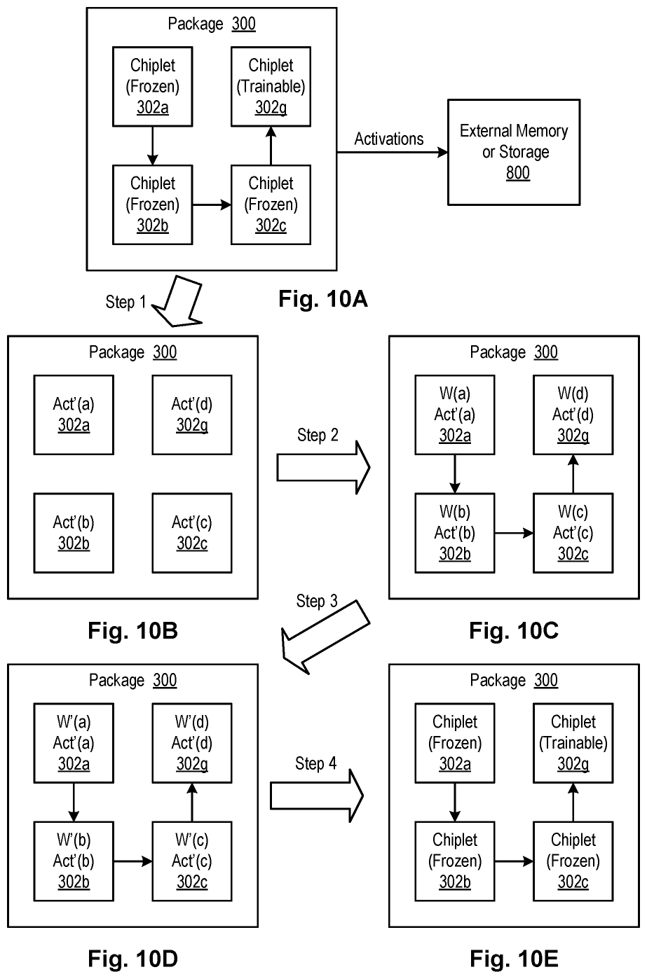

Referring to FIG. 10, as previously discussed in association with FIG. 8, in certain embodiments, activations from the frozen chiplets 302a-c (i.e., frozen layers 202a) may be stored in an external memory 800 or storage device 800 on or off chip over a significant period of time. These activations may then be read from the external memory 800 and processed on the trainable chiplet 302g in order to fine-tune the deep neural network 200 and/or facilitate transfer learning.

In an alternative embodiment, instead of processing all of the activations on the trainable chiplet 302g, the processing may be spread across all (or at least more) of the chiplets 302 on the package 300 to increase the efficiency of the training process. In order to accomplish this, the frozen chiplets 302a-c may be temporarily reprogrammed to assist in training the deep neural network 200, which as mentioned above is a computationally intensive task. This may provide more “workers” in performing the training and fine-tuning process.

For example, in a first step, weights and other parameters associated with the frozen layers 202a on the frozen chiplets 302 may be saved to external memory, which may include on-chip or off-chip memory. The activations that were stored in the external memory 800 (as was described in association with FIG. 8) may then be divided between the chiplets 302 (labelled as activation sub-components Act′(a), Act′(b), Act′(c), and Act′(d)). In certain embodiments these activation sub-components may correspond to different inference tasks, such as sentiment analysis, question and answer, instruction following, image classification, image segmentation, or the like.

In a second step, weights (labelled as W(a), W(b), W(c), and W(d)) may be copied to each of the chiplets 302 to perform the fine-tuning task. In a third step, fine-tuning training tasks may be concurrently run on each the chiplets 302 to adjust and optimize the weights (labelled as W′(a), W′(b), W′(c), and W′(d)). These optimized weights may then be saved to external memory. The chiplets 302a-c may then be reprogrammed again to re-implement the frozen layers 202a using the weights and other parameters that were previously saved to external memory. The weights (i.e., W′(a), W′(b), W′(c), and W′(d)) may be copied into the trainable chiplet 302g to finish the fine-tuning of the deep neural network 200.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for training and fine-tuning an artificial intelligence model, the method comprising:
distributing, across a plurality of chiplets of a package, functionality associated with a deep neural network;
implementing, within first set of chiplets of the plurality, frozen layers of the deep neural network; and
implementing, within a second set of chiplets of the plurality, trainable layers of the deep neural network.

2. The method of claim 1, further comprising imparting, to the second set of chiplets, at least one of additional memory capacity and additional memory bandwidth compared to the first set of chiplets.

3. The method of claim 2, wherein the additional memory capacity comprises 3D stacked memory capacity.

4. The method of claim 1, further comprising imparting, to the second set of chiplets, additional processing capacity compared to the first set of chiplets.

5. The method of claim 1, wherein the frozen layers are layers with frozen weights.

6. The method of claim 1, wherein the trainable layers are layers with adjustable weights.

7. The method of claim 1, wherein the second set of chiplets consists of a single chiplet.

8. The method of claim 1, further comprising storing, in a memory device, activations generated by the first set of chiplets for later training of the second set of chiplets.

9. The method of claim 1, wherein the chiplets of the first set are temporarily reprogrammed to include trainable layers during training of the deep neural network.

10. The method of claim 9, wherein the chiplets that are temporarily reprogrammed are configured to perform fine-tuning for different inference tasks, the different inference tasks comprising at least one of sentiment analysis, question and answer, instruction following, image classification, and image segmentation.

11. An apparatus for training and fine-tuning an artificial intelligence model, the apparatus comprising:
a package comprising a plurality of chiplets, wherein functionality associated with a deep neural network is distributed across the chiplets;
a first set of chiplets of the plurality of chiplets hosting frozen layers of the deep neural network; and
a second set of chiplets of the plurality of chiplets hosting trainable layers of the deep neural network.

12. The apparatus of claim 11, wherein the second set of chiplets include at least one of additional memory capacity and additional memory bandwidth compared to the first set of chiplets.

13. The apparatus of claim 12, wherein the additional memory capacity comprises 3D stacked memory capacity.

14. The apparatus of claim 11, wherein the second set of chiplets include additional processing capacity compared to the first set of chiplets.

15. The apparatus of claim 11, wherein the frozen layers are layers with frozen weights.

16. The apparatus of claim 11, wherein the trainable layers are layers with adjustable weights.

17. The apparatus of claim 11, wherein the second set of chiplets consists of a single chiplet.

18. The apparatus of claim 11, further comprising higher speed interfaces between chiplets of the second set than between chiplets of the first set.

19. The apparatus of claim 11, wherein the chiplets of the first set are temporarily reprogrammed to include trainable layers during training of the deep neural network.

20. The apparatus of claim 11, wherein the chiplets of the first set include frozen layers during inference operations of the deep neural network.
